(19) United States
(12) Patent Application Publication
(10) Pub. No.: US 2024/0104516 A1
(43) Pub. Date: Mar. 28, 2024

(54) REMANUFACTURING ORIENTATED OPERATIONS

(71) Applicant: INTERNATIONAL BUSINESS MACHINES CORPORATION, Armonk, NY (US)

(72) Inventor: Nosaiba Dar Mousa, Wappingers Falls, NY (US)

(21) Appl. No.: 17/950,758

(22) Filed: Sep. 22, 2022

(51) Int. Cl. G06Q 10/00; G06Q 10/04; G06Q 10/08

(52) U.S. Cl. CPC G06Q 10/30; G06Q 10/04; G06Q 10/0837; G06Q 10/087

(57) ABSTRACT

Making real-time operational decisions for remanufacturing operations by receiving data on return product including analysis of return product quality, and configuring the return product meeting quality threshold to commodity level. At least one dynamic optimization models is developed from data on the return product. A plan is created for a remanufacturing-oriented process from the at least one dynamic optimization models. The dynamic plan declares all activists required to build final product including all alteration and other activities such as disassembly, assembly, quantity needed from each return and replenishment quantity of new commodity. A final product is matched to an inventory of return product based on the plan for the remanufacturing-oriented process to provide a configuration recommendation.

### BACKGROUND

The present invention generally relates to modeling, and more particularly to employing models to recommend configurations useful in remanufacturing applications.

Building high tech configurable multi-generation products can be more complicated than other product types due to the variability in configuration combinations. Some parts are compatible with several generations. Some parts in the current generation of a product are suitable for the next generation of the product. In some instances, a product can be upgraded to the next generation by making a few changes to the product. The opposite can also be true. For example, products can be downgraded by making alterations. That kind of variability and alterations can disturb reverse supply chains, and can have impact on inventory management. Additionally, the aforementioned variability and alterations complicates remanufacturing production operations. Further, there are a number of different return processing pathways, such as: remanufacturing, refurbishing, recycling, reuse and disposal. Making various operational and tactical decisions including disassembly level and selecting return processing pathways and recoverable commodity utilization can be challenging. Current decision processes has heuristic rules and relies upon an experts opinion who may focus on fulfilling customer orders while potentially overlooking some details, such as available return inventory, or adequacy of resources for parts replacement.

### SUMMARY

In accordance with an embodiment of the present invention, a computer implemented method is provided for making real-time operational decisions. In one embodiment, the computer-implemented method is for generating a computer model and recommending a configuration in real time for operational decisions. In one embodiment, the computer implemented method may include receiving data on return product including analysis of return product quality; and configuring the return product meeting quality threshold to commodity level. The computer-implemented method can also include developing at least one dynamic optimization models from data on the return product; and creating a plan for a remanufacturing-oriented process from the at least one dynamic optimization models. A final product is then matched to an inventory of return product based on the plan for the remanufacturing-oriented process to provide a configuration recommendation.

In accordance with another aspect, a system for generating a computer model and recommending a configuration in real time for operational decisions is provided that includes a hardware processor; and memory that stores a computer program product. The computer program product when executed by the hardware processor, causes the hardware processor to receive data on return product including analysis of return product quality; and configure return product to commodity level. The computer program product when executed by a hardware processor can also develop at least one dynamic optimization models from data on the return product; and create a plan for a remanufacturing-oriented process from the at least one dynamic optimization models. The computer program product can also match a final product to an inventory of return product based on the plan for the remanufacturing-oriented process to provide a configuration recommendation.

In accordance with yet another aspect of the present disclosure, a computer program product is described for generating a computer model and recommending a configuration in real time for operational decisions. The computer program product can include a computer readable storage medium having computer readable program code embodied therewith. The program instructions are executable by a processor. The program instructions include to receive, using the processor, data on return product including analysis of return product quality; and configure, using the processor, return product to commodity level. The program instructions can also develop, using the processor, at least one dynamic optimization models from data on the return product; and create, using the processor, a plan for a remanufacturing-oriented process from the at least one dynamic optimization models. Match, using the processor, a final product to an inventory of return product based on the plan for the remanufacturing-oriented process to provide a configuration recommendation.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is an illustration of an environment illustrating an application for the data driven decision making method for remanufacturing orientated operation, in accordance with one embodiment of the present disclosure.

FIG. 2 is a flow chart/block diagram illustrating a system data driven decision making method for remanufacturing orientated operations, in accordance with one embodiment of the present disclosure.

FIG. 3 illustrates one embodiment of a flow chart for a data driven decision making method for remanufacturing orientated operations, in accordance with one embodiment of the present disclosure.

FIG. 4 is a block diagram illustrating a system that can incorporate the system for post combustion carbon capture, that are depicted in FIG. 2, in accordance with one embodiment of the present disclosure.

FIG. 5 depicts a computing environment according to an embodiment of the present disclosure.

### DETAILED DESCRIPTION

In some embodiments, the methods, systems and computer program products that are described herein can provide data driven decision making methods for remanufacturing orientated operations.

Building high tech configurable multi-generational products can be complicated due to variability in configuration combinations. High levels of variability can impact supply chains. Additionally, there are a number of different return processing pathways, such as: remanufacturing, refurbishing, recycling, reuse and disposal. “Remanufacturing” includes extracting and reconditioning commodity components for reuse and restore ETN conditions. “Refurbishing” includes two categories: (1) “repair”, which is about defining defects and fixing failed products and seeing them back to consumer, and (2) “reconditioning”, which includes rebuilding or replacing commodity components that do not function properly. “Recycling” is the act of recovering material content. “Reuseable items” are those products, parts and subassemblies that have serviceable quality. “Disposal” is for product in which all material is waste.

For the purposes of remanufacturing orientated operations, remanufacturing, reconditioning and repair are directed to product upgrades and recondition. The difference between remanufacturing, reconditioning and repair is a degree of improvement. Remanufacturing requires a greater degree of effort to recondition or upgrade products, and can start with the disassembly of a returned product. However, it may not be possible for all parts, and some of the parts may be reusable. The reusability of parts raises the question of whether a reusable part should be disassembled, as a suitable part may fill existing orders. For example, an inventory of useable parts may be a priority. There is a question of whether products should be disassembled for remanufacturing, or stored for resale, which may be dependent upon demand.

Making various operational and tactical decisions including the disassembly level and selecting return processing pathways and recoverable commodity utilization can be challenging. Current decision processes has heuristic rules and relies upon an experts opinion who may focus on fulfilling customer orders while potentially overlooking some details, such as available return inventory, or adequacy of resources for parts replacement.

It has been determined that the problem is identifying decisions related to production operations and inventory management in reverse supply chains starting from selecting return processing pathways to planning production operations with hybrid production systems. The present disclosure focuses on building hybrid (consists of new and recoverable commodities) configurable multi-generations products. The methods, systems and computer program products that are described herein develop a data driven decision system in which a real time optimization for operations decision includes selecting return pathways, replenishment and production operation, as well as a product configuration recommendation for offering.

In some embodiments, the methods, systems and computer program products can provide informative real time operational decisions. The decision making process can be divided into two stages. A first stage can be data preparation. A second stage can be a data driven dynamic optimization model.

In the first stage, data is collected from multiple systems. For example, a manufacturing order management system (OMS) can include a product configuration of each shipped order. The product configuration from the OMS system can provide a detailed configuration on the returned products. That data can be used as one source for data preparation for the methods, systems and computer program products that can provide informative real time operational decisions.

Another example of collecting data for the first stage may include field quality data. Field quality data includes the problem records for each product at a customer's site.

Another example of collecting data for the first stage may include e-configuration.

Yet another example of collecting data may include return inventory. The returns of products may serve as cores, and parts for refurbishing.

An even further source for data collection includes engineering requirements. Engineering requirements, such as product design and safety requirements, for products is information that helps with matching models and configurations of products for refurbishment. This type of data can help towards getting an understanding of how each return, and existing inventory, can be used for refurbishment.

The data from the above examples can be collected; integrated into a same data structure, e.g., database; and engineered for use.

The second stage includes the dynamic optimization model. In the second stage, two dynamic optimization models are developed to deal with the real time operation data and create a plan for remanufacturing orientated processes. The models represent sequential decisions for hybrid production systems. The hybrid productions systems can include “make to order” and “make to stock”.

Matching between a final product and a return can be a combinatorial problem. Combinatorial problems involve finding a grouping, ordering, or assignment of a discrete, finite set of objects that satisfies given conditions. Candidate solutions are combinations of solution components that may be encountered during a solutions attempt but need not satisfy all given conditions.

In some embodiments, the models, i.e., dynamic optimization models in the second stage, identify which return to be used for each order alternation to build each customer order, a replenishment policy, and dynamic degree for disassembly.

In some embodiments, the models, i.e., dynamic optimization models in the second stage, also develop configuration recommendations for products that can be built using the available inventory.

These recommendations can be used in sales offers. Exemplary applications/uses to which the present invention can be applied include, but are not limited to: reconditioning of computer parts, reconditioning of automotive parts, and reconditioning of consumer products.

The methods, systems and computer program products can create productions plans for remanufacturing processes. In some embodiments, the computer implemented methods, systems and computer products of the present disclosure provide the advantages of a real time operations decision operational model that include minimizing costs of remanufacturing operations, utilizing return inventory by maximizing the reusable, minimizing using new parts and reducing dependent demand on supplier for new inventory. Other advantages include identifying return disassemble level, customizing product operation to reduce rework and to propose configuration and product availability for offering to consumer.

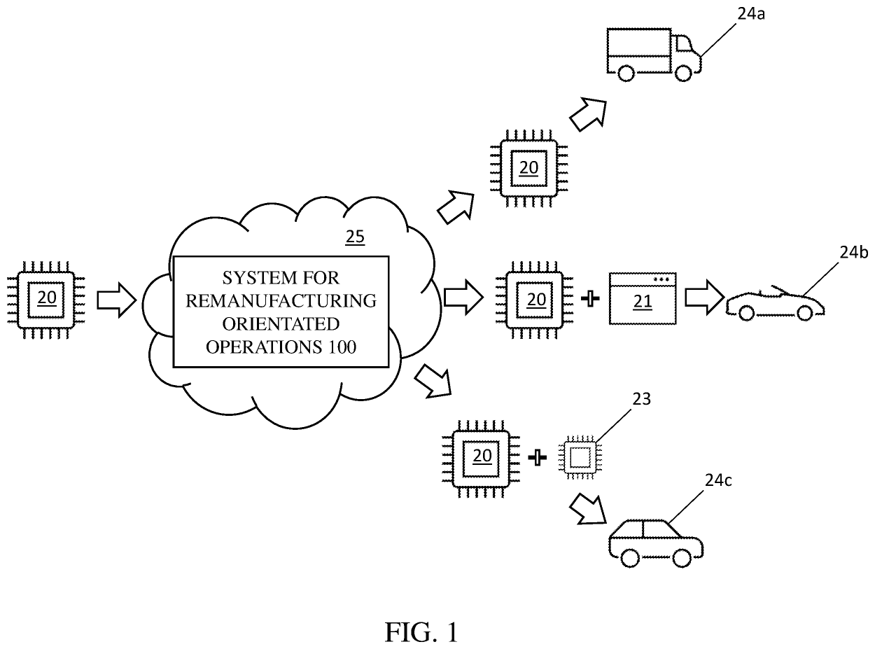

Referring now to the drawings in which like numerals represent the same or similar elements, the methods, systems and computer program products are now described in greater detail with reference to FIGS. 1-5.

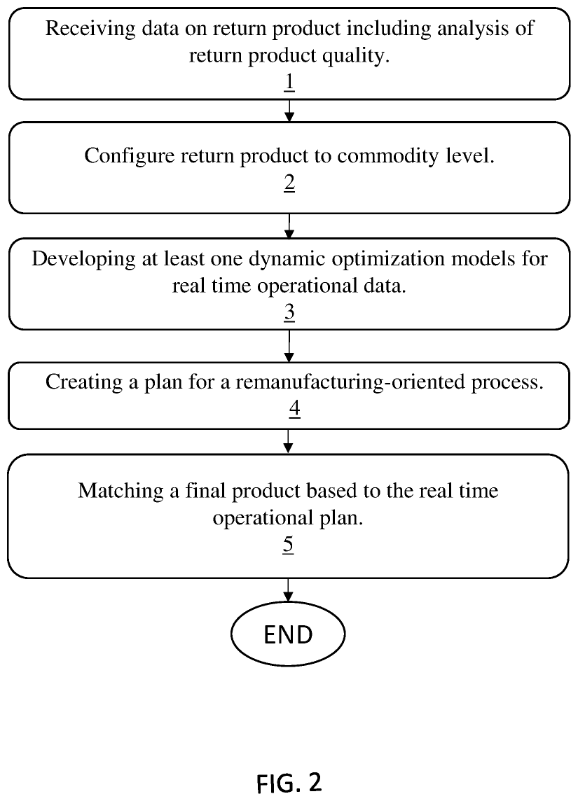

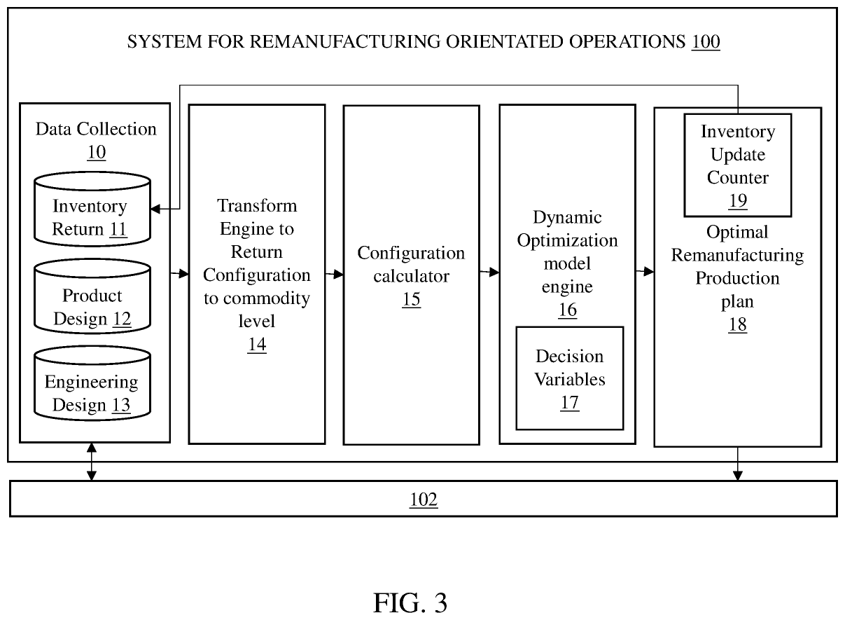

FIG. 1 is an illustration of an environment illustrating an application for the data driven decision making method for remanufacturing orientated operation. FIG. 2 is a flow chart/block diagram illustrating a system data driven decision making method for remanufacturing orientated operations. FIG. 3 illustrates one embodiment of a flow chart for a data driven decision making method for remanufacturing orientated operation w, in accordance with one embodiment of the present disclosure.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 1 illustrates one application for the remanufacturing orientated operations disclosed herein. In the example depicted in FIG. 1 a return component 20 is considered for remanufacturing operations. The methods, systems and compute program products that are described herein develop informative real-time operational decisions. As will be described below, the decision making process is dived into two stages (1) data preparation; and (2) data driven optimization models. These elements are provided by the system for remanufacturing orientated operations 100, which can be implemented as a cloud based service, i.e., using a cloud computing environment 25. As described herein, the system 100 can recommend products 20a, 20b, 20c that can be built using an inventory of return products 20. These recommendations can be used by sales teams to offer customers products. In some examples, in addition to making recommendations, the computer implemented methods, systems and computer program products can implement through manufacturing the recommendations, e.g., via actuators.

In some embodiments, the return products 20 may be repurposed in a replacement type application 20a, e.g., in which the return product is simply reconditioned for use in its originally used application. In some embodiments, the returned products 20 may be repurposes in a re-configured application 20b. For example, a configuration may be changed for the returned product 20 as part of the refurbishment process, which in some embodiments can be upgraded software 21. In the example depicted in FIG. 1, a return product 20 that was originally in an application for a first automotive model 24a can be re-configured for a second application, i.e., re-configured application 20b, which is suitable for use in a second automotive model 24b. In some embodiments, the returned products 20 may be repurposes in a configuration including new parts 23. For example, a configuration may include the returned product 20 in combination with a new part 23, to provide a hybrid product. In the example depicted in FIG. 1, a return product 20 that was originally in an application for a first automotive model 24a can be re-configured for a third application, i.e., re-configured application 20c, which is suitable for use in a third automotive model 24c, by modifying the original return 20 with new parts 23.

FIG. 2 illustrates one embodiment of a method for remanufacturing orientated operations including a matching model and configuration recommender. In one embodiment, a method is provided that includes receiving data on return product including analysis of return product quality at block 1 and configuring the return product to commodity level at block 2. Receiving data on the return product at block 1 can include receiving data including product configuration of each shipped order of a product at block 1; and receiving field quality data including problem records of the product at block 2. This represents some method steps of collecting data. Data collection can include product design data and engineering design data. Data collection also includes a determination of the available inventory of return product and feature lists, as well as an understanding of a feature's quantity options.

In some embodiments, data collection can include a quality assessment of the returns. For example, the quality assessment can include a determination of what components of the returns are suitable for reuse, and what components of the returns are not suitable for reuse. A component of the return suitable for reuse can contribute to remanufacturing steps. However, a component of the return not suitable for reuse, e.g., an unrepairable defective component, is not further used in remanufacturing operations.

Data collection also allows for aggregation for changes to inventory and products, e.g., upgrade, downgrade, and replacement. The idea is to aggregate all changes on product into the system that is configuring plans on how to use inventory in refurbishing operations. The changes aggregated include changes that occurred to return products while they were at the customer site. In this way, the system now has information on the return products final configuration when it is returned.

The data from the above examples can be collected; integrated into a same data structure, e.g., database; and engineered for use.

FIG. 3 illustrates one embodiment of a system 100 for remanufacturing orientated operations including a matching model and configuration recommender. The data collection 10 element of the system 100 includes databases of memory saved in the system 100. The databases include a module of memory for saving inventory 11, product design 12 and engineering design 13. Data for the product design 12 may be received from the manufacturing order management system (OMS), which includes product configuration of each shipped order. Other data for product design can include the field quality data, which includes problem records of each product on customer site. The engineering design data can include e-configuration, and engineering requirements includes products' design and safety requirements. The inventory 11 can be return inventory.

The data collected can then be integrated into a same data structure, e.g., database; and engineered for use.

At block 2, the method can include configuring the return product to commodity level. For example, the system may include a transformation engine that can transform the data from the return configuration to commodity level, i.e., transform engine 14 to return configuration to commodity level 14. By returning to a “commodity level”, it is meant that the return is brought back to a level when optional items or ancillary times can be removed so that the elements of the return can have multiple applications. The data from all the aforementioned input sources can provide the guidance for this type of modification to the commodity level.

Once the returns have been reduced to a commodity level, the method may continue with building configuration combinations for the returns. This again takes into account both the data from the input, and takes into account how the commodity level return can be repurposed for multiple applications.

Referring to FIG. 3, the configuration options may be calculated by a configuration calculator 15. This configuration calculator 15 considers the commodity level use of the returned product, and considers a number of constraints in determining what type of configuration options are suitable for the commodity, and the features of the commodity. The constraints may include engineering restrictions, design restrictions, mandatory feature quality, feature dependency, configurable features, mandatory features, and quantity range for configurable features.

In one example, building configuration combinations can include a process sequence that includes identifying a commodity feature that must be included in all configurations. This not only includes identifying the commodity feature, but also identify the number of commodity features that are needed in the different configurations. These are steps that are calculated by the configuration calculator 15. The configuration calculator 15 can also identify whether the commodity feature itself can be configurable, and how many configurations the commodity feature can have. Engineering restrictions and design restrictions can then be considered. From all these factors the configuration calculator 15 can generate configuration options.

Referring back to FIG. 2 in a following step, the method can progress to block 3. Block 3 includes developing at least one dynamic optimization model for real time operational data. In some embodiments, the method may further include developing two dynamic optimization models for real time operational data at block 3; and creating a plan for a remanufacturing-oriented process at block 4.

The two dynamic optimization models may be part of a cognitive data processing layer. The two dynamic optimization models can include make to order and make to stock. Matching between the final product, and the return (which has been reduced to commodity in some examples) is a combinatorial problem. The models can identify which return can be used for each customer order, the alternation needed to the return to build the customer order, a replenishment order, and a dynamic degree of disassembly needed to build the customer order from the return, e.g., the return in inventory. Referring to FIG. 3, in some embodiments, the dynamic optimization model engine 16 can perform the step of block 3 of the method described with reference to FIG. 2. The cognitive data processing layer of the model can identify the configurations to build using the configuration calculator 15 as an input. Some of the variables, e.g., decision variables and operational constraints, include engineering restrictions, design restrictions, mandatory feature quality, feature dependency, configurable features, mandatory features, and quantity range for configurable features. The variables described above are illustrated by reference number 17 in FIG. 3. One example of two dynamic optimization models for use with the methods, system and computer program products employs equation sets (1) and (2), according the notations in section (3), as follows:

(1) Equations Set: Make to Stock Optimization Model Part 1:

$$min {\sum }_{{k}_{o}} {\sum }_{o} {\sum }_{j} {z}_{{o}_{j}}^{{k}_{o}} vj + {\sum }_{{k}_{o}} {\sum }_{o} {\sum }_{j} {z}_{{o}_{j}}^{{k}_{o}} {C}_{j}^{A} + {\sum }_{{k}_{o}} {\sum }_{o} {\sum }_{i} {\sum }_{j} ( {y}_{i j o}^{{k}_{o}} {C}_{j}^{A} ) {c}_{{i}_{o}}^{{k}_{o}} + {\sum }_{{k}_{o}} {\sum }_{o} {\sum }_{i} {\sum }_{j} ( {y}_{i j o}^{{k}_{o}} {C}_{j}^{D} ) {c}_{{i}_{o}}^{{k}_{o}} + {\sum }_{{k}_{o}} {\sum }_{o} {\sum }_{i} {\sum }_{j} {y}_{i j o}^{{k}_{o}} {V}_{i j} + {\sum }_{{k}_{o}} {\sum }_{o} {\sum }_{i} {\sum }_{j} ( {m}_{i j o}^{{k}_{o}} {C}_{j}^{D} ) {b}_{i}^{{k}_{o}} + {\sum }_{{k}_{o}} {\sum }_{o} {\sum }_{i} {\sum }_{j} ( {y}_{i j}^{{k}_{o}} ) {b}_{i}^{{k}_{o}}$$

$$wherein :$$

$$min {\sum }_{{k}_{o}} {\sum }_{o} {\sum }_{j} {z}_{{o}_{j}}^{{k}_{o}} vj = new material cost$$

$${\sum }_{{k}_{o}} {\sum }_{o} {\sum }_{j} {z}_{{o}_{j}}^{{k}_{o}} {C}_{j}^{A} = assemble new part cost$$

$${\sum }_{{k}_{o}} {\sum }_{o} {\sum }_{i} {\sum }_{j} ( {y}_{i j o}^{{k}_{o}} {C}_{j}^{A} ) {c}_{{i}_{o}}^{{k}_{o}} = assemble reusable part cost$$

$${\sum }_{{k}_{o}} {\sum }_{o} {\sum }_{i} {\sum }_{j} ( {y}_{i j o}^{{k}_{o}} {C}_{j}^{D} ) {c}_{{i}_{o}}^{{k}_{o}} = complementary disassemble cost$$

$${\sum }_{{k}_{o}} {\sum }_{o} {\sum }_{i} {\sum }_{j} {y}_{i j o}^{{k}_{o}} {V}_{i j} = reusable material cost$$

$${\sum }_{{k}_{o}} {\sum }_{o} {\sum }_{i} {\sum }_{j} ( {m}_{i j o}^{{k}_{o}} {C}_{j}^{D} ) {b}_{i}^{{k}_{o}} = base disassemble cost$$

$${\sum }_{{k}_{o}} {\sum }_{o} {\sum }_{i} {\sum }_{j} ( {y}_{i j}^{{k}_{o}} ) {b}_{i}^{{k}_{o}} = base material cost$$

$$and the : Max {\sum }_{o} {k}_{o}$$

$$subject to :$$

$${\sum }_{i} {y}_{i j o}^{{k}_{o}} + {z}_{o j}^{{k}_{0}} = {O}_{j} , \qquad {∀}_{j} , {k}_{o} , o \qquad Total reused and new quantities of each commodity matches commodity quantity on specific condition .$$

$${z}_{o j}^{{k}_{o}} = {O}_{j - {\sum }_{i} {y}_{ijo}^{{k}_{o}}} , \qquad {∀}_{o , j} , {k}_{o} \qquad Total reused and new quantities of each commodity matches commodity quantity on specific condition .$$

$$\begin{matrix}If {b}_{{i}_{o}}^{{k}_{o}} = 1 , then {m}_{i j o}^{{k}_{o}} = {A}_{i j} - {y}_{i j o}^{{k}_{o}} , & {∀}_{o , j} , {k}_{o} , j\end{matrix} \qquad Calculate quantity to disassemble for each Selected base to match quantity of commodity j on option o .$$

$${\sum }_{i} {b}_{io}^{{k}_{o}} = 1 \qquad {∀}_{j} , {k}_{o} \qquad Only one return is selected to build a remanufactured product for each configuration quantity .$$

$${\sum }_{{k}_{o}} {\sum }_{o} {b}_{i o}^{{k}_{o}} = 1 \qquad {∀}_{i} \qquad Return is selected as a base for only one remanufactured product .$$

(2) Equations Set: Make to Stock Optimization Model Part 2:

$${c}_{i}^{{k}_{o}} = 0 if \qquad {\sum }_{j} {y}_{i j o}^{{k}_{o}} \geq 1 \& {b}_{i o}^{{k}_{o}} = 1 , \qquad {∀}_{i} , o , {k}_{o} \qquad To ensure it is not complementary if selected as a base$$

$${c}_{i}^{{k}_{o}} = 0 if \qquad {\sum }_{j} {y}_{i j o}^{{k}_{o}} \geq 1 \& {b}_{i o}^{{k}_{o}} = 1 , \qquad {∀}_{i} , o , {k}_{o} \qquad To ensure it is not complementary if it is not selected as a base$$

$${c}_{i}^{{k}_{o}} = 0 \& {b}_{i o}^{{k}_{o}} = 0 if \qquad {\sum }_{j} {y}_{i j o}^{{k}_{o}} = 0 , \qquad {∀}_{i} , o , {k}_{o} \qquad To ensure it is not complementary or a base if nothing has been used .$$

$${y}_{i j o}^{{k}_{o}} \geq 0 \qquad {∀}_{i} , j , o , {k}_{o}$$

$${m}_{i j o}^{{k}_{o}} \geq 0 \qquad {∀}_{i} , j , o , {k}_{o}$$

$${z}_{o j}^{{k}_{o}} \geq 0 \qquad {∀}_{i} , j , {k}_{o}$$

$${y}_{i j o}^{{k}_{o}} , {z}_{o j}^{{k}_{o}} , {x}_{i j o}^{{k}_{o}} , {k}_{o} = integers$$

$${b}_{i o}^{{k}_{o}} , {c}_{i}^{{k}_{o}} = binary$$

(3) Notations and Decision Variables:

Indices (description):
j=commodity option (j: 1 . . . J); number of commodities.
i=number of available returned machine (i: 1 . . . I). I number of returns.
o=number of configuration options (o: 1, . . . , O). O is number of configurations.
kₒ=quantity of product to be build for each configuration option (k: 1, . . . , K).

Notation (Description):
Oⱼ=Quality of commodity j in option o.
Aᵢⱼ=Quality of commodity j in available return i.
Vᵢⱼ=Value of each commodity j in return i.
vⱼ=Cost of each new commodity j.
Cⱼ^{A}=Cost of assembling commodity j per unit.
Cⱼ^{D}=Cost of disassembling commodity j per unit.

Notation (Decision Variable Description):
yᵢⱼₒ^{k}^{ₒ}=Selected complementary quantity from commodity j in return I to build configuration o in quantity kₒ.
Zₒⱼ^{k}^{ₒ}=Quantity of new commodity j for option o in quantity kₒ.
cᵢₒ^{k}^{ₒ}=Selected return i selected as a complementary to match configuration o in quantity kₒ.
bᵢₒ^{k}^{ₒ}:=Selected return i selected as based to build option o in quantity kₒ.
mᵢⱼₒ^{k}^{ₒ}=Quantity to disassemble from commodity j in selected return i as a base to match configuration o in quantity kₒ.

Block 4 of FIG. 2, in a subsequent step, the method may include creating a plan for a remanufacturing orientated process at block 4. The plan is created for a remanufacturing-oriented process from the at least one dynamic optimization models. The plan is dynamic and includes all alterations and activities required to build final products.

Block 4 can include an output for a quantity needed of the commodity returns for each configuration to be built, the assembly required to fulfill orders for each configuration to be built, a level of disassembly needed for the orders, a level of disassembly of the returns to best match the configuration of the orders, the degree by which the configurations assembled from the returns match the order and a replenishment policy for returns. Referring to FIG. 3, the plan for the remanufacturing process at block 4 may be implemented by the dynamic optimization model engine 16. The system also allows for aggregation for changes, e.g., upgrade, downgrade, replacement, that overtime into the plan.

Referring to FIG. 2, the computer implemented method may continue with block 5. Block 5 includes matching a final product based on the real time operational plan. Block 5 can include operations to match to inventory and define dynamic replenishment. Dynamic replenishment can include a new commodity that is need to finalize a product.

In some examples, the method may continue with developing a configuration recommendation for a product based on available inventory based on the two dynamic optimization models. The real time operational plan is based on the inventory. As illustrated in FIG. 3, the system 100 may include an inventory update counter 19. The inventory update counter 19, provides adjustments to inventory to be stored for the next round of orders. As illustrated in FIG. 3, the inventory update counter 19 is in communication with the inventory of returns 11 in the data collection 10 component of the system 100. Because the inventory update counter 19 is updating the inventory of returns in the data collection 10 component of the system 100, and the data collection 10 is used by the configuration calculator 15, and the dynamic optimization model engine 16, which is used by the optimal remanufacturing production plan 18 to suggest products, the system 100 can provide for real-time operation decisions.

The advantages of using the real-time operational decision model can include minimizing cost of remanufacturing operations, utilizing return inventory by maximizing reusable components, minimizing using new parts, and reducing dependent demand on suppliers for new inventory.

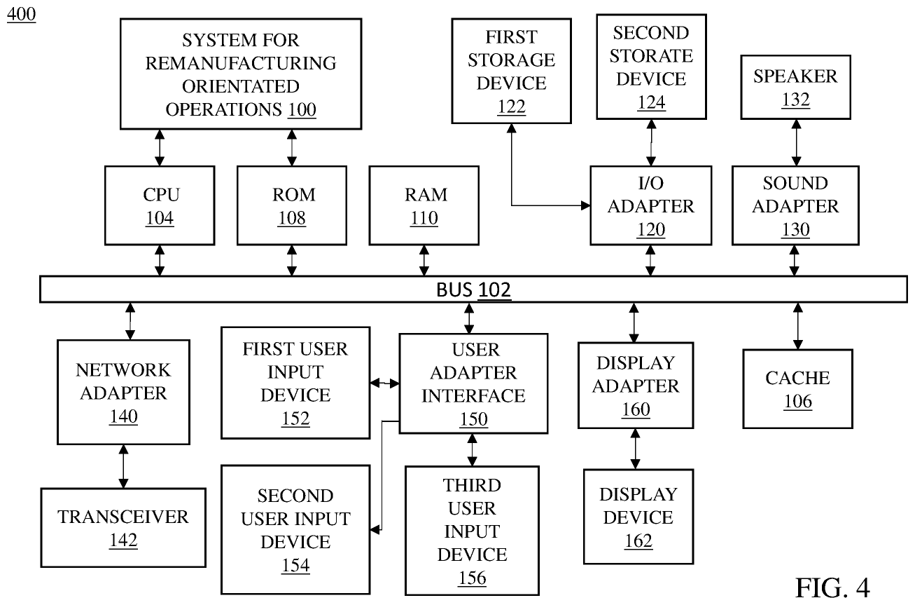

Referring to FIG. 3, in some embodiments, the components of the system 100 are interconnected by a bus 102. The bus 102 may also be in communication with at least one hardware processor, in which the hardware processor may function with the other elements depicted in FIG. 3 to provide the functions described above. FIG. 4 further illustrates a processing system 400 that can include the system 100 for remanufacturing orientated operations described with reference to FIGS. 1-3. The exemplary processing system 400 to which the present invention may be applied is shown in accordance with one embodiment. The processing system 400 includes at least one processor (CPU) 104 operatively coupled to other components via a system bus 102. The system bus 102 may be in communication with the system for ranking materials for post combustion carbon capture 200. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102. As illustrated, the system 100 that provides for provenance based identification of policy deviations in cloud environments can be integrated into the processing system 400 by connection to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 400.

Of course, the processing system 400 may also include other elements (not shown), as readily contemplated by one of skill in the art, as well as omit certain elements. For example, various other input devices and/or output devices can be included in processing system 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 400 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

The present invention may be a system, a method, and/or a computer program product at any possible technical detail level of integration. For example, in some embodiments, a computer program product is provided for making real-time operational decisions for remanufacturing operations. The computer program product can include a computer readable storage medium having computer readable program code embodied therewith. The program instructions are executable by a processor. The program instructions include to receive, using the processor, data on return product including analysis of return product quality; and configure, using the processor, return product to commodity level. The program instructions can also develop, using the processor, at least one dynamic optimization models from data on the return product; and create, using the processor, a plan for a remanufacturing-oriented process from the at least one dynamic optimization models. Match, using the processor, a final product to an inventory of return product based on the plan for the remanufacturing-oriented process to provide a configuration recommendation.

The computer program product may include a computer readable storage medium (or media) having computer readable program instructions thereon for causing a processor to carry out aspects of the present invention. The computer program produce may also be non-transitory.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing.

A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

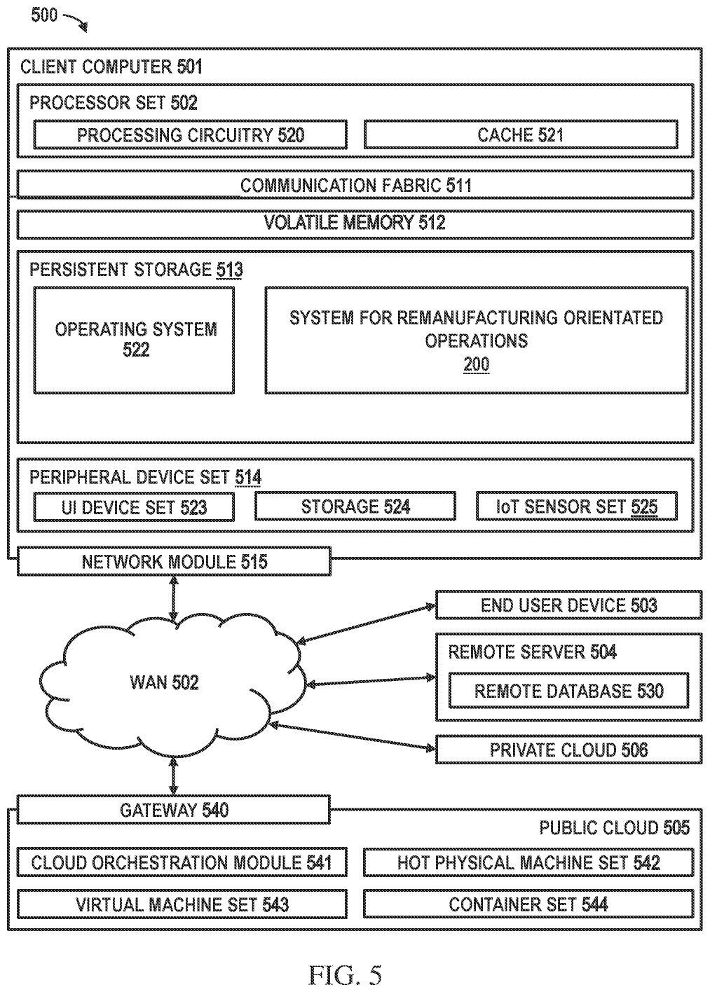

Referring to FIG. 5, the computing environment 500 contains an example of an environment for the execution of at least some of the computer code involved in performing the inventive methods, such as the method for ranking materials for post combustion carbon capture 200. In addition to block 200, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 200, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible.

Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 200 in persistent storage 513.

COMMUNICATION FABRIC 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 101 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 101 to communicate with other computers through WAN 102. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515. WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments,

EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method for ranking materials for post combustion carbon capture (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for making operational decisions comprising:
receiving data on return product including analysis of return product quality;
configuring the return product meeting quality threshold to commodity level;
developing at least one dynamic optimization models from data on the return product;
creating a plan for a remanufacturing-oriented process from the at least one dynamic optimization models; and
matching a final product to an inventory of return product based on the plan for the remanufacturing-oriented process to provide a configuration recommendation.

2. The computer-implemented method of claim 1, wherein the matching of the final product to the inventory of return product based on the plan for the remanufacturing-oriented process to provide the configuration recommendation includes a combinational problem.

3. The computer-implemented method of claim 1, wherein the configuration recommendation is for remanufacturing operations.

4. The computer-implemented method of claim 1 further comprising updating the inventory of return product following production of the final product in real time.

5. The computer-implemented method of claim 1, wherein the at least one optimization model comprises at least one of a make to order model and make to stock model.

6. The computer-implemented method of claim 1, wherein the receiving data on the return product comprises receiving data including return product configuration of each shipped order of the return product, and receiving field quality data including problem records of the return product.

7. The computer-implemented method of claim 1, wherein the remanufacturing-oriented process for the return product includes reconditioning for a same application, refurbishment with a new configuration for a new application, and refurbishment with new hardware.

8. A system for making operational decisions comprising:
a hardware processor; and
a memory that stores a computer program product, the computer program product when executed by the hardware processor, causes the hardware processor to:
receive data on return product including analysis of return product quality;
configure return product to commodity level;
develop at least one dynamic optimization models from data on the return product;
create a plan for a remanufacturing-oriented process from the at least one dynamic optimization models; and
match a final product to an inventory of return product based on the plan for the remanufacturing-oriented process to provide a configuration recommendation.

9. The system of claim 8, wherein the match of the final product to the inventory of return product based on the plan for the remanufacturing-oriented process includes a combinational problem.

10. The system of claim 8, wherein the configuration recommendation is for remanufacturing operations.

11. The system of claim 8 further comprising updating the inventory of return product following production of the final product in real time.

12. The system of claim 8, wherein the at least one optimization model comprises at least one of a make to order and made to stock model.

13. The system of claim 8, wherein the receiving data on the return product comprises receiving data including return product configuration of each shipped order of the return product, and receiving field quality data including problem records of the return product.

14. The system of claim 8, wherein the remanufacturing-oriented process for the return product includes reconditioning for a same application, refurbishment with a new configuration for a new application, and refurbishment with new hardware.

15. A computer program product is described for making operational decisions, the computer program product can include a computer readable storage medium having computer readable program code embodied therewith, the program instructions executable by a processor to cause the processor to:
receive, using the processor, data on return product including analysis of return product quality;
configure, using the processor, return product to commodity level;
develop, using the processor, at least one dynamic optimization models from data on the return product;
create, using the processor, a plan for a remanufacturing-oriented process from the at least one dynamic optimization models; and
match, using the processor, a final product to an inventory of return product based on the plan for the remanufacturing-oriented process to provide a configuration recommendation.

16. The computer program product of claim 15, wherein the match of the final product to the inventory of the return product based on the plan for the remanufacturing-oriented process to provide the configuration recommendation includes a combinational problem.

17. The computer program product of claim 15, wherein the configuration recommendation is for remanufacturing operations.

18. The computer program product of claim 15 further comprising updating the inventory of return product following production of the final product in real time.

19. The computer program product of claim 15, wherein the at least one optimization model comprises at least one of a make to order and made to stock model.

20. The computer program product of claim 15, wherein the receiving data on the return product comprises receiving data including return product configuration of each shipped order of the return product, and receiving field quality data including problem records of the return product.
